(19) United States
(12) Patent Application Publication
(10) Pub. No.: US 2005/0039830 A1
(43) Pub. Date: Feb. 24, 2005

(54) Induction heat treatment method and coil and article treated thereby

(76) Inventors: Mark Christofis, Troy, MI (US); Michael Walter Hopson, Clinton Township, MI (US); Ted Szczomak, Shelby Township, MI (US); Norman Szalony, Brighton, MI (US); Robert W. Sams, Clinton Township, MI (US); Richard Lawrence Seidel, Macomb, MI (US); William Paul Bogen, Ann Arbor, MI (US)

Correspondence Address: Douglas A. Mullen;Dickinson Wright PLLC, Suite 800, 1901 L Street N.W., Washington, DC, 20036, US

(21) Appl. No.: 10/643,362

(22) Filed: Aug. 19, 2003

(51) Int. Cl. C21D 1/10; H05B 6/36

(52) U.S. Cl. 148/575; 219/674

(57) ABSTRACT

A method of induction heat treating the outer surface of articles having an irregular surface shape. The method employs an induction coil that provides a non-planar magnetic field that is adapted to the irregular shape of the article, such that distinct sections of the induction coil produce distinct magnetic fields that are adapted to induce currents in, and thereby provide heat to, distinct sections of the outer surface of the article. The method and induction coil are particularly adapted to provide an induction hardening heat treatment for the outer surfaces of the inner races of Rzeppa-type constant velocity joints.

### FIELD OF THE INVENTION

The present invention relates to a method of induction heat treatment. More specifically, the invention comprises a method for induction hardening certain metal components, particularly those having a shape that prevents uniform induction coupling over the surface which is to be hardened. Most particularly, the invention comprises a method for induction hardening the steel inner race of Rzeppa-type constant velocity joints.

### BACKGROUND OF THE INVENTION

Induction heat treatment is known to be an effective method of case hardening steels having a microstructure comprising a mixture of pearlite and ferrite. For example, induction hardening has been widely used for the case hardening of various types of steel gears. However, induction hardening has significant limitations in cases where the surface requiring heat treatment is irregular, such as gears having relatively larger teeth where the distance from the tip to the root of a tooth is such that the electromagnetic coupling, and hence induction heating, varies significantly from the tip to the root. While some solutions have been proposed to facilitate the use of induction hardening with articles having irregular surfaces, such as the use of different coils and different induction frequencies to treat different portions of the surface, or the use of coil designs that are adapted to the contour of the irregularities in order to provide more uniform inductive coupling, induction hardening has not been used for various types of components, such as those described below.

The Rzeppa-type constant velocity (CV) joint is widely used in automotive vehicles. It is most frequently used in conjunction with halfshafts, the name given to the two driveshafts or axle shafts that run from the transaxle to the wheels in front wheel drive vehicles. Because it is widely used in automotive vehicles, the Rzeppa joint is manufactured in relatively high volumes. The Rzeppa joint typically utilizes 6 or 8 steel balls, which move in corresponding grooves of a steel inner race and outer housing and are retained by a slotted cage, to transmit power between the two shafts while at the same time permitting the angulation of the joint.

The inner race of the Rzeppa joint transmits torque between the axle shafts. Its outer surface is subjected to various wear mechanisms related to both the motion of the balls within arch-shaped ball grooves formed in the outer surface, as well as the sliding of the bearing portions of the outer surface over the inner surface of the steel cage that is used to retain the balls.

While variations exist in the designs for and materials used in Rzeppa joints of different manufacturers, the inner race is typically formed by forging a pearlitic/ferritic steel blank and then performing various metal forming, finishing and heat treatment steps to produce the required properties, such as the hardness of the outer surface. Typically, the outer surface of the inner race is hardened by carburizing. The use of carburizing for case hardening has a number of well-known limitations. These include the fact that the process treats the entire surface of the inner race, the material and processing costs associated with the process, the processing time necessary to heat the parts to temperature and produce the required carburized case depth, as well as limitations related to process control, batch processing, capital expense and facility requirements for large furnaces, environmental issues, and control of the finished part quality. The carburizing process has the potential to form undesirable microstructural constituents, such as carbides, grain boundary oxidation, decarburization and retained austenite that can affect further functionality of the finished part.

Therefore, it is desirable to develop a method of heat treatment that addresses the limitations mentioned above and that provides a method for surface or case hardening parts having an irregular surface, such as the inner race of Rzeppa-type CV joints.

### SUMMARY OF THE INVENTION

The present invention provides a method of induction heat treatment of an outer surface of an inner ball race of a Rzeppa-type constant velocity joint, said outer surface also having a plurality of ball races formed therein, comprising the steps of: selecting an induction coil having a longitudinal axis, a semi-cylindrical upper coil portion, a semi-cylindrical lateral coil portion and a semi-cylindrical lower coil section, that is adapted to receive the inner race and apply a non-planar magnetic field to the outer surface thereof; placing the article within the induction coil; rotating the inner race within the induction coil at a selected speed; energizing the induction coil to apply the non-planar magnetic field and produce induction currents within the outer surface of the inner race for a time sufficient to induce heating of the outer surface to a heat treatment temperature (T_{H}) to at least a selected case depth; and cooling the outer surface of the article to a temperature (T_{C}) to the selected case depth.

The invention also comprises a steel inner race of a Rzeppa-type constant velocity joint having a barrel-shaped outer surface and a core, the barrel-shaped outer surface having a plurality of angularly spaced apart, longitudinally extending, arch-shaped ball races, the outer surface including the plurality of arch-shaped ball races having a hardened case, wherein the hardened case is formed by an induction heat treatment.

The invention also comprises an induction coil that is uniquely designed for use with components having an irregular outer surface, and includes a hollow metal channel comprising a first termination portion, a generally cylindrical inductor portion and a second termination portion, the inductor portion comprising a first semi-cylindrical upper section which is connected to a first semi-cylindrical lateral section which extends downwardly and is connected to a semi-cylindrical lower section which is connected to a second semi-cylindrical lateral section which extends upwardly and is connected to a second semi-cylindrical upper section, wherein the first termination section is connected to an end of the first semi-cylindrical upper section that is opposite the first semi-cylindrical lateral section, and the second termination portion is connected to an end of the second semi-cylindrical upper section that is opposite the second semi-cylindrical lateral section, wherein the first termination portion, cylindrical portion and second termination portion are operably connected to one another and adapted to conduct an induction current.

Certain difficulties associated with the inductive heat treatment of components having an irregular outer surface, such as the inner race of Rzeppa-type CV joints, have been overcome by the use of the method of heat treatment and induction coil described herein.

The present invention undertakes to improve the production of such components as compared to previous methods, such as carburizing, by enabling the use of induction hardening, and thereby providing better control over the process by hardening one component at a time, improving the metallurgical and mechanical properties of the components, and allowing for a reduction in heat treatment cost.

The hardening operation will be simplified, and allow improved control, by the application of this invention because the components will be processed one at a time. The integration of the part location, heating, and quenching functions into a single, robust machine simplifies the heat treatment operation compared to previous methods by reducing the part handling requirements and reducing complex cycle parameters (e.g. adjusting the entire process for part-to-part variations in a batch of parts due to different temperature and environmental conditions that exist in a large heat treating furnace) to a small set of control parameters for each individual part (e.g. power, induction time, quench flow rates, etc.). Enabling the automatic control of process variables, such as the power level, total power delivered, quench temperature, quench flow rate, and cycle timing parameters, along with other process variables, will enable improved process control.

The mechanical properties of the components may also be improved by the selective application of heat in only the areas where high hardness is desired to give more precise control over the hardness and wear properties of the critical areas of the component while minimizing distortion from the hardening process.

Benefits from this invention include increased component strength (as compared to components processed by conventional methods such as carburizing), use of lower cost materials, shortened process times, reduced forging costs, reduced distortion, improved microstructures, improved tool life, deeper case depth capabilities, and the use of cellular process lines.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a top schematic view illustrating an inner race placed within an induction coil according to the present invention.

FIG. 2 is a front schematic view of the inner race and induction coil of FIG. 1.

FIG. 3 is a flowchart illustrating the steps of the method of the invention.

FIG. 4 is a top view of an inner race of a Rzeppa-type constant velocity joint that has been induction hardened by the method of the invention.

FIG. 5 is a section view of the inner race of FIG. 4 taken along section 5-5.

FIG. 6 is a section view of the inner race of FIG. 4 taken along section 6-6.

### DETAILED DESCRIPTION OF THE PREFERRED EMBODIMENT

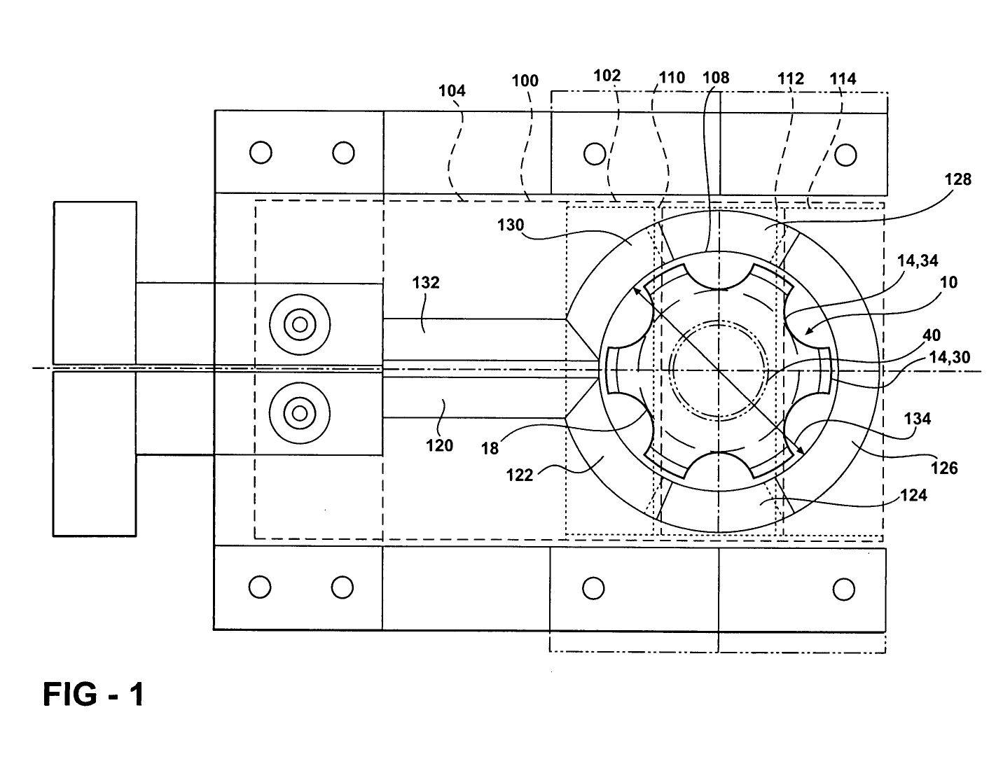

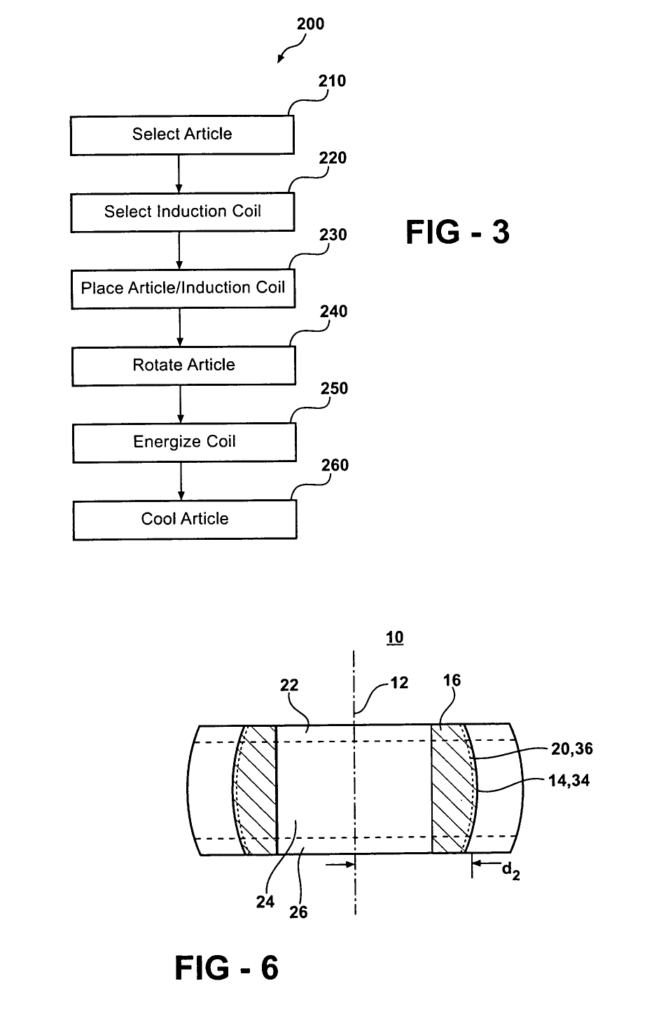

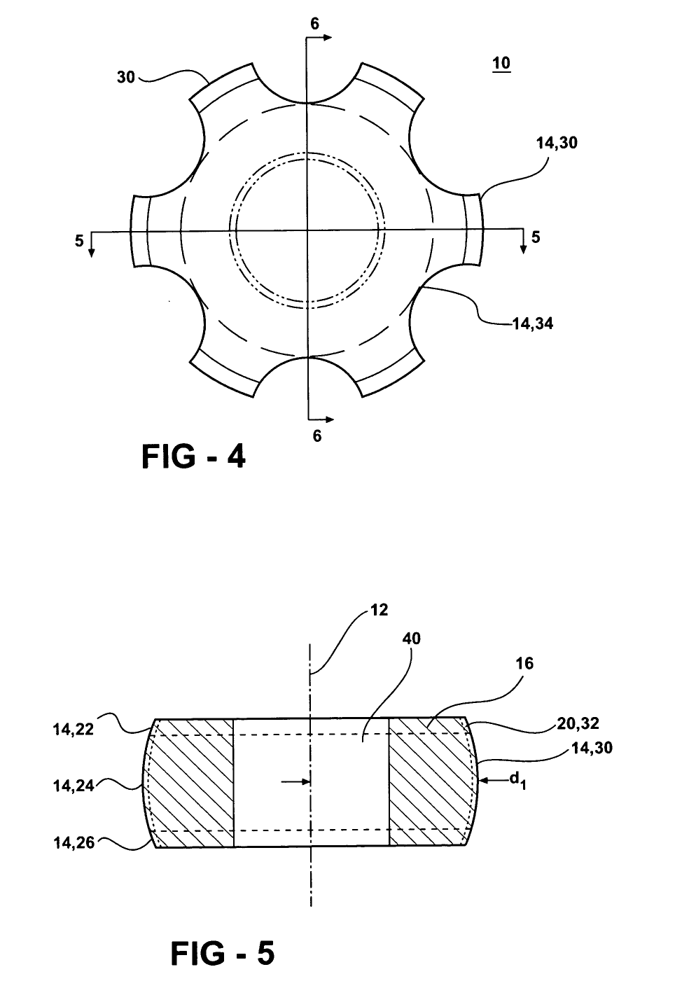

Referring to FIGS. 1-3, the present invention generally comprises a method of induction heat treatment 200 of a metal article 10 by means of an induction coil 100, and comprises the steps of: selecting 210 an article 10 for heat treatment having a longitudinal axis of rotation 12 and an outer surface 14 having an upper section 26, a lateral section 27 and a lower section 28, and comprising a plurality of points, such as d₁ and d₂ as illustrated in FIGS. 5 and 6, having a plurality of normal spacings from the axis of rotation; selecting 220 an induction coil 100 comprising a semi-cylindrical upper coil portion 102, a semi-cylindrical lateral coil portion 104, a semi-cylindrical lower coil portion 106 and a longitudinal axis 108, which is adapted to receive the article 10 for heat treatment and apply a non-planar magnetic field to the outer surface 14 of the article 10; placing 230 the article 10 within the induction coil 110; rotating 240 the article 10 within the induction coil 100 at a selected speed; energizing 240 the induction coil 110 to apply the non-planar magnetic field and produce induction currents within the outer surface 14 of the article 10 for a time sufficient to induce heating of the outer surface 14 to a heat treatment temperature (T_{H}) to at least a selected case depth; and cooling 250 the outer surface 14 of the article 10 to a temperature (T_{C}) to the selected case depth. The method of heat treatment 200, article 10, and induction coil 100 are described more particularly below.

With regard to the step of selecting 210 an article 10, this method of induction heat treatment 200 is ideally suited for the induction heat treatment of articles 10 having outer surfaces 14 that are irregular, in that the normal spacing or distance of the points that comprise outer surface 14 from longitudinal axis 12 varies, both as a function of the angular position and through the thickness of article 10. This is illustrated generally in FIGS. 5 and 6, wherein the outer surface 14 may be described as a plurality of points d₁, d₂, . . . dₙ. In the case of article 10 shown in FIGS. 5 and 6, the range of the spacing of the points that comprise outer surface 14 is the difference in normal distances d₁ and d₂. This irregularity of the spacing of the points of outer surface 14 is important because if article 10 is placed in the center of a standard induction coil, such as a cylindrical induction coil, this variation in distance or spacing also serves to define the spacing from the induction coil, and more particularly, the degree of inductive coupling that will be produced in the points of outer surface 14, such as d₁ and d₂, when the coil is energized. This has a significant effect on the heat treatment of article 10, because the degree of inductive coupling is directly related to the heat treatment temperature that will result at these points as the inductive coil is energized.

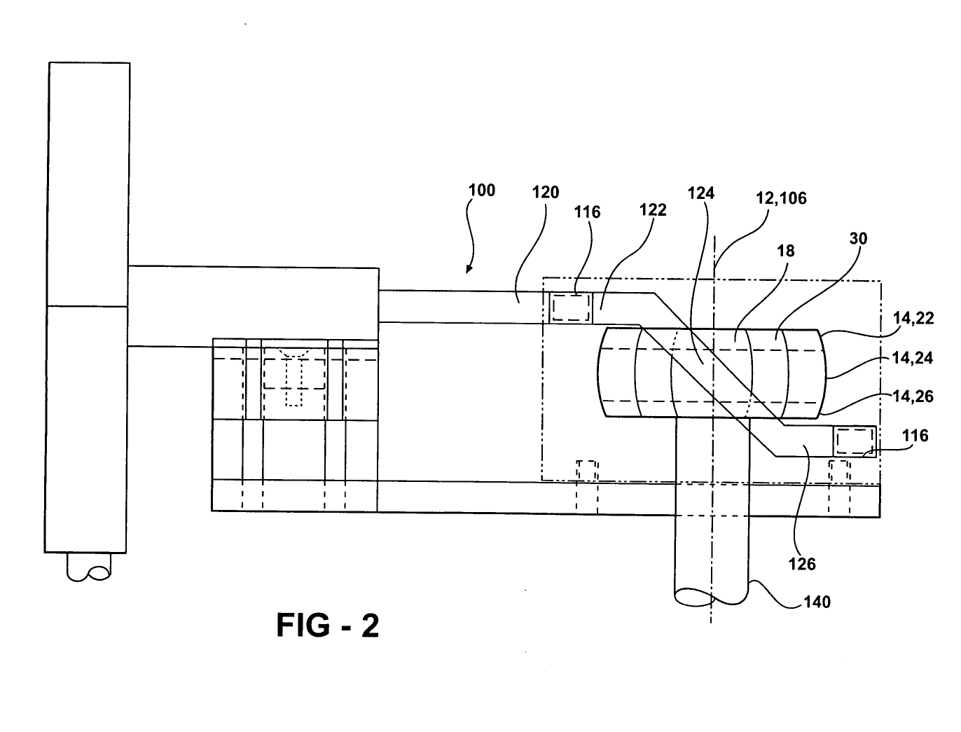

While it is believed that the method of the present invention may be used for the induction heat treatment of a number of articles 10 having irregular spacing of the points that comprise their outer surfaces 14, such as certain types of gears, hubs and other articles, FIGS. 1-2 illustrate a particular embodiment of an article 10 comprising an inner race 10 of a Rzeppa-type constant velocity joint that has been induction heat treated using method 200. When method 200 comprises an induction hardening heat treatment, article 10 will comprise an induction hardenable metal, such as a medium to high carbon steel having a microstructure comprising a mixture of pearlite and ferrite. Induction hardenable steels are referred to herein as pearlitic/ferritic steels. Inner race 10 was generally cylindrical, having a maximum diameter of about 69 mm and a thickness of about 28.5 mm and comprised AISI 1050 warm forged steel. Inner race 10 comprised an outer surface 14 and a core 16. Outer surface 14 was generally convex or barrel-shaped. Outer surface 14 also comprised a plurality of angularly spaced apart, longitudinally extending, arch-shaped ball races 18 formed therein. Ball races 18 were generally cylindrical, having a diameter of about 21 mm. In the embodiment illustrated in FIGS. 1 and 2, there were 6 arch-shaped ball races, associated with a 6 ball joint, however, the present invention is also applicable to 8 ball joints and other Rzeppa-type joints having different numbers of ball/ball races. Inner race 10 also comprised a bore 40, which was a splined bore 40.

Referring to FIGS. 5 and 6, it was an object of the induction heat treatment 200 to form a hardened case 20 over the entirety of outer surface 14. Outer surface 14 may be described as comprising two general regions. The first region is associated with the generally cylindrical portion of outer surface 14, and may be referred to as a plurality of bearing surfaces 30, over which it was an object to form a corresponding plurality of bearing portions 32 of case 20. The second region may be referred to as a plurality of ball race surfaces 34, over which it was an object to form a corresponding plurality of ball race portions 36 of case 20.

When inner race 10 is incorporated into a Rzeppa joint, the bearing surfaces 30 bear against an inner surface of a cage (not shown) used to retain the balls (not shown) that comprise the ball joint. Bearing surfaces 30 are primarily subjected to wear associated with the sliding of the race and cage surfaces over one another as a CV joint incorporating inner race 10 is angulated during operation of a vehicle. It is, however, also important that bearing surfaces 30 and bearing portions 32 of case 20 be able to support the loads placed upon the CV joint without the deformation or crushing of bearing portions 32 of case 20, or the development of subsurface fatigue cracks. Ball race surfaces 34 and ball race portions 36 of case 20 are primarily used to transmit torque from the balls to the inner race 10 and the CV joint outer housing (not shown). Ball race surfaces 34 and ball race portions 36 of case 20 are primarily subjected to wear caused by the movement of balls in ball races 18, and tensile and compressive stresses as torque is applied from the balls into inner race 10 and the CV joint outer housing.

Rzeppa type joints are presently made by a number of manufacturers. This being the case, there are many variations in the particular features and details of Rzeppa type joints and their associated inner races 10, including variations of the size, including the thickness and diameter, the degree and type of curvature of outer surface 14, the number and shape of arch-shaped ball races 18, the composition of the material and methods used to form inner race 10, and other features. However, while some differences exist, most comprise pearlitic/ferritic steels and it is believed that the present invention is applicable to many of the Rzeppa joints currently being manufactured.

Having selected 210 inner race 10, the method of heat treatment 200 comprised the additional step of selecting 220 an induction coil 100. Referring to FIGS. 1 and 2, the induction coil 100 selected comprised a generally cylindrical coil 100 (see FIG. 1) having a generally cylindrical portion 102, a termination portion 104, and a longitudinal axis 106. Referring to FIG. 1, by generally cylindrical, it is meant that induction coil 100 and cylindrical coil portion 102 appear to be cylindrical as viewed from their top surfaces, and generally sweep out a cylindrical shape in space, as defined by inner surface 108. Generally cylindrical portion 102 comprises upper coil portion 110, lateral coil portion 112 and lower coil portion 114. Upper coil portion 110 comprises a first semi-cylindrical upper coil section 122 and a second semi-cylindrical upper coil section 130. Lateral coil portion 112 comprises a first semi-cylindrical lateral coil section 124 and a second semi-cylindrical lateral coil section 128. Lower coil portion 126 comprises a single semi-cylindrical section 126. As shown in FIGS. 1 and 2, termination portion 104 comprises a first termination section 120 and a second termination section 132. First and second termination section 120,132 are adapted to connect inductive coil 100 to a power supply. While the arrangement of elements is provided to illustrate an embodiment of inductor coil 100, the coil is not limited to the particular embodiment shown. For example, termination portion 104 could be incorporated into either of lateral portion 104 or lower portion 106, with a corresponding rearrangement of the other elements of induction coil 100. Referring again to FIGS. 1 and 2, induction coil 100 may comprise any suitable size, cross-sectional shape and composition, depending on the exact nature of article 10 that is to be used therewith. However, in the case of inner race 10, induction coil 100 had an effective diameter 134 of 73 mm and comprised a hollow, rectangular, pure copper tube 116 having an internal width of 10.4 mm and an internal height of 7.2 mm, and sidewall thickness of 1.1 mm. While many conductive materials may be used for induction coil 100, it is preferably made from pure copper tubing, generally having a purity of at least 99%. Induction coil 100 must be adapted so as to receive article 10, while preferably maintaining as close as spacing as is practicable, so as to maximize the inductive coupling with article 10 when induction coil is energized, and yet not interfere with the rotation of article 10, as discussed below. Induction coil 100 is preferably adapted so that longitudinal axis 12 of article 10 may be easily aligned to be parallel to and coincident with longitudinal axis 106.

Induction coil 100 is also adapted to apply a non-planar magnetic field to the outer surface 14. By non-planar, it is meant that the centerline of the magnetic field that results when induction coil 100 is energized, which roughly corresponds to the centerline of the tube, is non-planar. Referring to FIGS. 1 and 2, the magnetic field that is produced when induction coil 100 is energized may be described as being generally cylindrical as explained above. Induction coil 100 is adapted such that upper coil portion 110, comprising first semi-cylindrical upper coil section 122 and second semi-cylindrical upper coil section 130, produces corresponding upper magnetic fields that are adapted to act on an upper section 22 of outer surface 14, and lateral coil portion 112, comprising first semi-cylindrical lateral coil section 124 and second semi-cylindrical lateral coil section 128, produces corresponding lateral magnetic fields that are adapted to act on lateral section 24 of outer surface 14, and lower coil portion 114, comprising a single semi-cylindrical section 126, produces a lower magnetic field that is adapted to act on lower section 26 of outer surface 14.

The next step of method 200 comprises placing 230 article 10 within the induction coil. Placing 230 comprises providing a rotatable means for holding article 10 in position for the subsequent steps of method 200. As discussed above and illustrated in FIG. 2 with regard to inner race 10, inner race 10 is preferably placed within induction coil 100 so that longitudinal axis 12 is parallel to and coincident with longitudinal axis 106. Inner race 10 may be placed into induction coil 100 by any suitable means 140 for holding and rotating inner race 10, such as a rotatable jig or fixture, and is illustrated in FIG. 2 as rotatable shaft 140. It is also preferable that means for holding and rotating inner race 10 be selected so as to minimize any interference with the magnetic fields generated by induction coil 100.

The next step of method 200 comprises rotating 240 the inner race 10 within the induction coil 110 at a selected speed. This speed may be any suitable speed and may comprise a variable speed during or within the subsequent steps of method 200. Rotation is used to compensate for the fact that induction coil 100 has a region where termination portion 104 and generally cylindrical portion 102 meet where the resultant magnetic field is non-uniform and generally reduced as compared to adjacent sections of the induction coil. Further, because the induction coil is non-planar, and applies distinct upper, lateral and lower magnetic fields, as described above, rotation is necessary in order that all of upper section 22, lateral section 24 and lower section 26 of outer surface 14 of article 10 are uniformly exposed to the corresponding magnetic fields when induction coil 100 is energized. In the case of inner race 10, inner race 10 was rotated at about 150 rpm during induction heat treatment 200.

The next step of method 200 comprises energizing 250 the induction coil 100 to a selected energy level to apply the non-planar magnetic field and produce induction currents within outer surface 14 of article 10. To provide induction hardening, this step must be performed for a time sufficient to induce heating of outer surface 14 to a heat treatment temperature (TH) to at least a selected case depth, such as the required or desired hardened case depth. As illustrated in FIGS. 1 and 2, in the case of inner race 10, and induction coil 100, the step of energizing 240 comprised applying 30% power from a commercially available 400 kW power supply of a type used for induction heat treatment in a range of about 7.5-15 kHz, and preferably about 10 kHz, for about 3.5 seconds. In the case of inner race 10, this step of energizing 250 was sufficient to heat all of outer surface 14 to a temperature that was above the austenite transition temperature to selected case depth of at least 1 mm over the entirety of outer surface 14. The austenite transition temperature for the AISI 1050 material is about 1700-2000° F. The actual depth of the heat treatment ranged from about 1-1.8 mm in the ball race portions 34 and about 2.5-5 mm on bearing portions 30. It will be readily understood that the inductive frequency and power can be altered depending on the size, shape, degree of irregularity, composition and other factors associated with article 10, the specific design of inductor coil 100, as well as other factors.

The next step of method 200 comprises cooling 260 outer surface 14 of article 10 to a temperature (T_{C}) to the selected case depth. This temperature (T_{C}) can be any temperature that is lower than the heat treatment temperature (T_{H}), but typically will be selected to produce certain desired transformation products within case 20. In the case of inner race 10, the desired transformation product in case 20 was martensite, hence, T_{C} was selected to be below the martensite transformation temperature, which in the case of AISI 1050 was about 200° F. Cooling 250 comprised quenching inner race 10 in an aqueous quenchant comprising 3-5% Aqua Quench 251, for a time sufficient to lower inner race 10 below T_{C}. Quenching was accomplished by pumping a large volume of the quenchant onto the part. Quenching 250 was accomplished using standard quench blocks 150 having numerous spray holes in the surfaces facing induction coil 100. The quench time for inner race 10 was about 15 seconds at a flow rate of about 15-20 gpm.

Referring to FIGS. 5 and 6, following the step of cooling 250, the surface hardness of inner race 10 at outer surface 14 was in the range of R_{C} 58-63, with a hardened case 20 depth range of approximately 1.0-5.0 mm effective at R_{C} 50, and a core 16 hardness of R_{C} 15-30. The microstructure comprised martensite in outer surface 14 and case 20, and fine grains of pearlite and ferrite in core 16. Bearing surfaces 30 and their associated bearing portions 32 of case 20, having a hardened case depth of about 2.5-5.0 mm, and ball race surfaces 34 and their associated ball race portions 36 of case 20 having a hardened case depth of about 1-1.8 mm.

Applicants believe that in addition to standard means of tempering the martensite, such as an oven tempering heat treatment at a temperature of 325° F., it is also possible to use method 200 to produce a tempered martensite structure in case 20 by controlling the step of cooling 260 so that outer surface 14 is cooled by quenching such that T_{C} is below the martensite start (Mₛ) temperature (about 610° F.), but greater than the martensite finish temperature (about 200° F.), and then permitting the part to cool under ambient conditions, such that the martensitic structure is tempered by the reduced cooling rate. Quench concentration, temperature, flow rates and time are adjusted to allow the use of residual heat to sufficiently temper (stress relieve) the part, thereby eliminating the need for secondary tempering processing. It is believed that this will reduce the residual stress in case 20, as well as the hardness to a range of about 58-61 R_{C}.

Following induction heat treatment 200, inner race 10 may optionally be hard turned to produce the finished dimensions of the component.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A method of induction heat treatment, comprising the steps of:
selecting an article for heat treatment having a longitudinal axis of rotation and an outer surface having an upper section, a lateral section and a lower section, and comprising a plurality of points having a plurality of normal spacings from the axis of rotation;
selecting an induction coil comprising a semi-cylindrical upper coil portion, a semi-cylindrical lateral coil portion, a semi-cylindrical lower coil portion and a longitudinal axis, which is adapted to receive the article for heat treatment and apply a non-planar magnetic field to the outer surface of the article;
placing the article within the induction coil;
rotating the article within the induction coil at a selected speed;
energizing the induction coil to apply the non-planar magnetic field and produce induction currents within the outer surface of the article for a time sufficient to induce heating of the outer surface to a heat treatment temperature (T_{H}) to at least a selected case depth; and
cooling the outer surface of the article to a temperature (T_{C}) to the selected case depth.

2. The method of claim 1, wherein the article comprises a pearlitic/ferritic steel.

3. The method of claim 2, wherein T_{H} is greater than the austenite transition temperature.

4. The method of claim 3, wherein said step of cooling comprises quenching the article.

5. The method of claim 4, wherein said step of cooling comprises quenching until T_{C} is lower than the martensite transformation temperature.

6. The method of claim 1, wherein the article comprises an inner ball race of a Rzeppa-type constant velocity joint having a barrel-shaped outer surface with a plurality of longitudinally extending arch-shaped grooves formed therein.

7. The method of claim 6, wherein the inner ball race comprises a pearlitic/ferritic steel.

8. The method of claim 7, wherein the steel comprises AISI 1050 steel.

9. The method of claim 7, wherein T_{H} is greater than the austenite transition temperature.

10. The method of claim 9, wherein the T_{H} is in the range of 1700-2000° F.

11. The method of claim 9, wherein said step of cooling comprises quenching the article.

12. The method of claim 11, wherein T_{C} is less than the martensite start temperature and greater than the martensite finish temperature .

13. The method of claim 12, further comprising stopping the quenching when the outer surface of the inner race is less than or equal to T_{C} to the selected case depth, and then permitting the inner race to cool under ambient conditions.

14. The method of claim 1, wherein during the step of energizing, the upper coil portion produces an upper magnetic field that is adapted to act on the upper section of the outer surface, the lateral coil portion produces a lateral magnetic field that is adapted to act on the lateral section of the outer surface, and the lower coil portion produces a lower magnetic field that is adapted to act on the lower section of the outer surface.

15. The method of claim 14, wherein the step of energizing comprises the application of an electric current to the induction coil having a frequency in the range of about 7.5-12 kHz.

16. A method of induction heat treatment of an outer surface of an inner ball race of a Rzeppa-type constant velocity joint, said outer surface also having a plurality of ball races formed therein, comprising the steps of:
selecting an induction coil having a longitudinal axis, a semi-cylindrical upper coil portion, a semi-cylindrical lateral coil portion and a semi-cylindrical lower coil portion, that is adapted to receive the inner race and apply a non-planar magnetic field to the outer surface thereof;
placing the article within the induction coil;
rotating the inner race within the induction coil at a selected speed;
energizing the induction coil to apply the non-planar magnetic field and produce induction currents within the outer surface of the inner race for a time sufficient to induce heating of the outer surface to a heat treatment temperature (T_{H}) to at least a selected case depth; and
cooling the outer surface of the article to a temperature (T_{C}) to the selected case depth.

17. The method of claim 16, wherein the inner race comprises a pearlitic/ferritic steel.

18. The method of claim 17, wherein the steel comprises AISI 1050 steel.

19. The method of claim 17, wherein T_{H} is greater than the austenite transition temperature.

20. The method of claim 19, wherein T_{H} is in the range of 1700-2000° F.

21. The method of claim 19, wherein said step of cooling comprises quenching the article.

22. The method of claim 21, wherein said step of cooling comprises quenching until T_{C} is lower than the martensite start temperature.

23. The method of claim 22, wherein T_{C} is greater than the martensite finish temperature.

24. The method of claim 23, further comprising stopping said step of cooling by quenching when the outer surface of the inner race is less than or equal to T_{C} to the selected case depth, and permitting the inner race to cool under ambient conditions.

25. An article, comprising:
a steel inner race of a Rzeppa-type constant velocity joint having a barrel-shaped outer surface and a core, the barrel-shaped outer surface having a plurality of angularly spaced apart, longitudinally extending, arch-shaped ball races, the outer surface including the plurality of arch-shaped ball races having a hardened case, wherein the hardened case is formed by an induction heat treatment.

26. The article of claim 25, wherein the induction heat treatment comprises the steps of selecting an induction coil having a longitudinal axis, a semi-cylindrical upper coil portion, a semi-cylindrical lateral coil portion and a semi-cylindrical lower coil portion, that is adapted to receive the inner race and apply a non-planar magnetic field to the outer surface thereof; placing the article within the induction coil; rotating the inner race within the induction coil at a selected speed; energizing the induction coil to apply the non-planar magnetic field and produce induction currents within the outer surface of the inner race for a time sufficient to induce heating of the outer surface to a heat treatment temperature (T_{H}) to at least a selected case depth; and cooling the outer surface of the article to a temperature (T_{C}) to the selected case depth.

27. The article of claim 26, wherein the induction hardened case comprises a martensitic microstructure and the core comprises a microstructure that is a mixture of pearlite and ferrite.

28. The article of claim 27, wherein the induction hardened case has a hardness of about R_{C} 58-63, and the core has a hardness of about R_{C} 15-30.

29. The article of claim 27, wherein the martensitic microstructure is a tempered martensitic microstructure.

30. The article of claim 29, wherein the tempered martensitic microstructure is formed by the induction heat treatment.

31. The article of claim 30, wherein the tempered martensitic microstructure has a hardness of about R_{C} 58-61.

32. The article of claim 31, wherein the depth of the case is about 1-1.8 mm in the arch-shaped ball races and about 2.5-5 mm on the bearing portions.

33. An induction coil, comprising:
a hollow metal channel comprising a first termination portion, a generally cylindrical inductor portion and a second termination portion, the inductor portion comprising a first semi-cylindrical upper section which is connected to a first semi-cylindrical lateral section which extends downwardly and is connected to a semi-cylindrical lower section which is connected to a second semi-cylindrical lateral section which extends upwardly and is connected to a second semi-cylindrical upper section, wherein the first termination section is connected to an end of the first semi-cylindrical upper section that is opposite the first semi-cylindrical lateral section, and the second termination portion is connected to an end of the second semi-cylindrical upper section that is opposite the second semi-cylindrical lateral section, wherein the first termination portion, cylindrical portion and second termination portion are operably connected to one another and adapted to conduct an induction current.

34. The induction coil of claim 33, wherein the hollow channel is rectangular having an outer width of about 12.7 mm and an outer height of about 9.5 mm and a wall thickness of about 1.1 mm.

35. The induction coil of claim 33, wherein the metal is pure copper.
